(19) United States
(12) Patent Application Publication
(10) Pub. No.: US 2014/0304712 A1
(43) Pub. Date: Oct. 9, 2014

(54) METHOD FOR OPERATING TASK AND ELECTRONIC DEVICE THEREOF

(71) Applicant: Samsung Electronics Co., Ltd., Suwon-si (KR)

(72) Inventors: Seong Joon KIM, Busan (KR); Young Taek KIM, Suwon-si (KR); Do Young LEE, Suwon-si (KR); Byeong Yun LEE, Suwon-si (KR)

(73) Assignee: Samsung Electronics Co., Ltd., Suwon-si (KR)

(21) Appl. No.: 14/246,541

(22) Filed: Apr. 7, 2014

(30) Foreign Application Priority Data
Apr. 8, 2013 (KR) 10-2013-0038275

(51) Int. Cl. G06F 9/50

(52) U.S. Cl. CPC G06F 9/5088
USPC 718/105

(57) ABSTRACT

A method and a device for operation a task in an electronic device are provided. The method for operating a task in an electronic device includes generating at least one task on a protocol layer basis based on a work to process, executing at least one task generated on a layer basis through at least one Central Processing Unit (CPU), determining whether a workload to process is changed, and changing, if the workload to process is changed, a workload of the executing of the at least one task.

### CROSS-REFERENCE TO RELATED APPLICATION(S)

This application claims the benefit under 35 U.S.C. §119(a) of a Korean patent application filed on Apr. 8, 2013 in the Korean Intellectual Property Office and assigned Serial number 10-2013-0038275, the entire disclosure of which is hereby incorporated by reference.

### TECHNICAL FIELD

The present disclosure relates to a method for operating a task and an electronic device thereof.

### BACKGROUND

Nowadays, in order to improve a performance of a calculation device, use of a multi-core processor is in an enlarging trend. More particularly, in an embedded system in which much calculation is needed, in order to provide a real time service, a multicore processor is applied.

In User Equipment (UE) Category 3 of Long Term Evolution (LTE) Release 8, it is defined that a modem of a terminal supports traffic of about a maximum of 100 Mbps for a downlink. Based on such situation, because an LTE-Advanced (LTE-A) system that sets an International Mobile Telecommunications (IMT)-Advanced specification as a target should support traffic of 1 Gbps, the LTE-Advanced system should support a calculation work about 10 times greater than that of a modem defining in UE Category 3 of LTE Release 8. For this, a research of a method for processing in parallel much calculation by applying a multicore processor needs to be conducted.

However, application of a multicore processor in this manner needs a large change in a programming paradigm and a software model of the related art. For example, a sequential programming method is appropriate in improving a performance with a method for increasing an operation clock of a single core of the related art, but the sequential programming method is not appropriate to a development environment of a multicore embedded system that improves performance based on a parallel processing of a given work.

Nowadays, a programming technique based on a plurality of tasks, a plurality of processes, or a plurality of threads is provided. However, such techniques do not consider an environment in which a workload that should process is extremely changed.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide an embedded system that operates a task based on a varying workload and power efficiency in an electronic device.

Another aspect of the present disclosure is to provide an embedded system that operates a task based on a component carrier in an electronic device.

Another aspect of the present disclosure is to provide an embedded system that generates, divides, or combines a task according to a varying workload in an electronic device.

Another aspect of the present disclosure is to provide an embedded system that operates a task on each layer basis of a protocol in an electronic device.

Another aspect of the present disclosure is to provide an embedded system that operates a task using a plurality of Central Processing Unit (CPU) cores in an electronic device.

In accordance with an aspect of the present disclosure, a method for operating a task in an electronic device is provided. The method includes generating at least one task on a protocol layer basis based on a work to process, executing at least one task generated on the layer basis through at least one CPU, determining whether a workload to process is changed, and changing, if a workload to process is changed, a workload of the executing of the at least one task.

In accordance with another aspect of the present disclosure, a device for operating a task in an electronic device is provided. The device includes an embedded system configured to generate at least one task on a protocol layer basis based on a work to process, to execute at least one task generated on the layer basis through at least one CPU, to determine whether a workload to process is changed, and to change a workload of the executing of the at least one task, if a workload to process is changed.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 illustrates an execution entity in a protocol layer structure and each layer structure of an Long Term Evolution Advanced (LTE-A) system according to an embodiment of the present disclosure;

FIG. 2 illustrates a method for operating a task based on each protocol layer in an embedded system according to an embodiment of the present disclosure;

FIG. 3 illustrates a method for operating a task using one Central Processing Unit (CPU) core in an embedded system according to an embodiment of the present disclosure;

FIG. 4 illustrates a method for operating a task using a plurality of CPU cores in an embedded system according to an embodiment of the present disclosure;

FIG. 5 illustrates a method for operating a task based on a plurality of threads using a plurality of CPU cores in an embedded system according to an embodiment of the present disclosure;

FIG. 6 is a block diagram illustrating a configuration for controlling a task in an embedded system according to an embodiment of the present disclosure;

FIGS. 7A, 7B, and 7C illustrate a task generation, a division, and a combination according to a varying workload in an embedded system according to an embodiment of the present disclosure; and

FIG. 8 is a flowchart illustrating a task operation procedure in an embedded system according to an embodiment of the present disclosure.

Throughout the drawings, it should be noted that like reference numbers are used to depict the same or similar elements, features, and structures

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide.

In an electronic device of various embodiments of the present disclosure, an embedded system that operates a task will be described based on a varying workload and power efficiency. Hereinafter, in an embodiment of the present disclosure, for convenience of description, a method for operating a task is exemplified based on a protocol layer structure of a Long Term Evolution Advanced (LTE-A) system. For example, in an LTE-A system, a component carrier corresponding to one transport channel supports downlink traffic of 100 Mbps and uplink traffic of 50 Mbps. However, an embodiment to be described hereinafter is not limited to the LTE-A system and may be applied with the same method even to another system having a plurality of protocol layer structures or another system having a plurality of transport channels. Further, in the following description, a method for operating a task may be applied to an embedded system that supports a single core and may be applied to an embedded system that supports a multi core.

In an embodiment of the present disclosure, a new task may be generated and operated, executing at least two tasks may be combined and operated to one task, or executing one task may be divided and operated into at least two tasks based on a workload changed in real time in a single core or multicore embedded system. For example, in an embedded system, when a superfast-speed is needed, a plurality of tasks may be generated and a plurality of tasks may be processed using at least one Central Processing Unit (CPU) core. In another example, in an embedded system, in other CPU cores, when a workload of independently or individually operating tasks is smaller than or equal to a workload that can process in real time in one CPU core, tasks operating in each of other CPU cores are combined to one task, and the combined one task may be processed using one CPU core. In another embodiment of the present disclosure, in an embedded system, when a workload of executing one task is more than a workload that can process in real time in one CPU core, a corresponding task may be divided into at least two tasks and the divided tasks may be processed in at least two CPU cores. Examples of the above-described task generation, combination, and division are some embodiment of various embodiments of the present disclosure and a range of the present disclosure is not limited thereto.

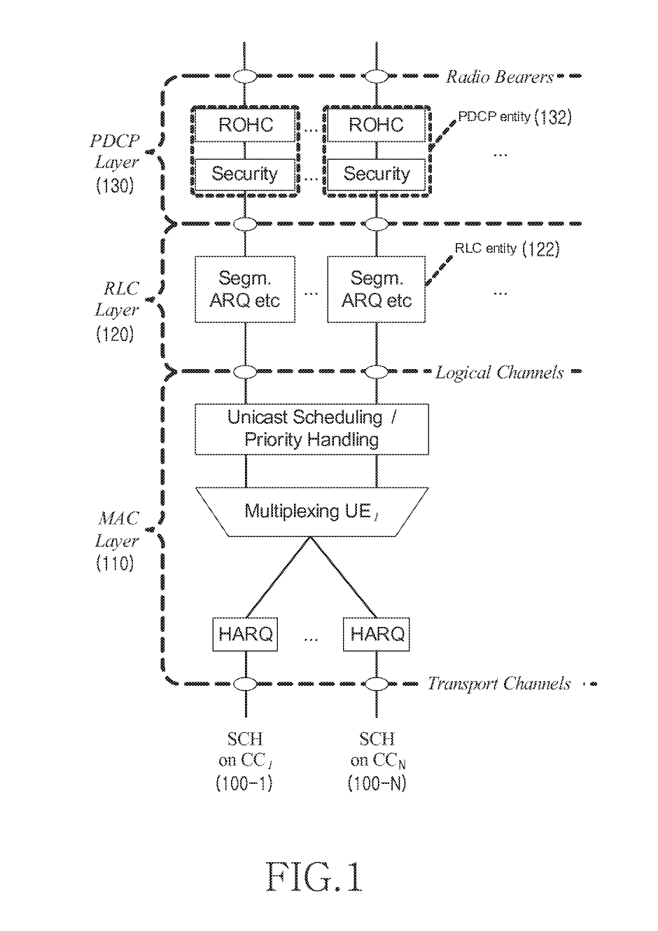

FIG. 1 illustrates an execution entity in a protocol layer structure and each layer structure of an LTE-A system according to an embodiment of the present disclosure.

Referring to FIG. 1, the LTE-A system may include a plurality of transport channels corresponding to each of a plurality of component carriers (100-1 to 100-N). Further, the LTE-A system may include a Media Access Control layer (MAC layer) 110, a Radio Link Control layer (RLC layer) 120, and a Packet Data Convergence Protocol layer (PDCP layer) 130. Here, each layer may have an execution entity. For example, the RLC layer 120 may include a separate RLC execution entity 122 on a logical channel basis, and the PDCP layer 130 may include PDCP execution entities 132 of the number corresponding to that of execution entities of the RLC layer 120. In this case, each execution entity of the RLC layer 120 and the PDCP layer 130 should process data of from 0 kbps to 1 Gbps according to a situation. Further, in the MAC layer 110, an entity MAC layer may be formed with one execution entity, and the MAC layer 110 may be formed with execution entities of the number corresponding to that of component carriers. For example, when the number of component carriers in which the LTE-A system supports is 5, the MAC layer 110 may be formed with five MAC execution entities. When the MAC layer 110 is formed with one execution entity, the MAC execution entity should perform a processing of one component carrier to five component carriers and thus, should process data from 0 kbps to 1 Gbps. However, when the MAC layer 110 is formed with MAC execution entities of the number corresponding to that of component carriers, each MAC execution entity should perform data processing of one component carrier and should thus, process downlink data from 0 kbps to 100 Mbps.

Hereinafter, it is assumed that a device has a protocol layer structure and an execution entity shown in FIG. 1, and a method for operating a task will be described. However, this is an illustration and various embodiments suggested in the present disclosure may be applied to a system of another method.

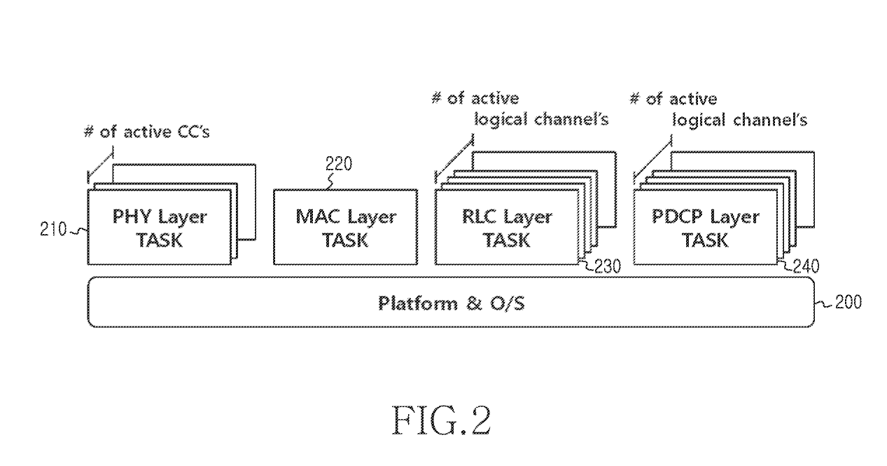

FIG. 2 illustrates a method for operating a task based on each protocol layer in an embedded system according to an embodiment of the present disclosure.

Referring to FIG. 2, a task operation method based on a protocol layer structure of FIG. 1 is illustrated. In the embedded system, one task may be operated on each task basis. For example, one task may be operated on a layer basis and one or a plurality of tasks may be operated according to a characteristic of each layer.

As shown in FIG. 2, because a PHY layer has a characteristic that requests a processing on a component carrier basis, in an embedded system, a plurality of tasks 210 of the same property on a component carrier basis of the PHY layer may operate in a platform and operating system 200. For example, in an embodiment of the present disclosure, in the PHY layer, in order to process a plurality of component carriers, a task may be previously designed and defined on one component carrier basis and thus, in the embedded system, a task of each component carrier is generated in the PHY layer according to a design and definition. For example, when a first component carrier and a second component carrier operate, in the embedded system, by generating a first PHY layer task of the first component carrier and by generating a second PHY layer task of the second component carrier, a PHY layer processing of a corresponding component carrier is performed with each PHY layer task.

Further, when a MAC layer has a characteristic that an integrated single processing is requested, in the embedded system, one task 220 of the MAC layer may operate in the platform and operating system 200. This assumes a situation in which an entire MAC layer is formed with one execution entity, and as an entire MAC layer is formed with a plurality of execution entities, when the MAC layer has a characteristic that a separate processing is requested on a component carrier basis, in the embedded system, a task may be operated on an execution entity basis of the MAC layer.

Further, because an RLC layer and a PDCP layer each have a characteristic that a processing on a logic channel basis is needed, in the embedded system, a plurality of tasks 230 and 240 of the same property may operate in the platform and operating system 200 on a logic channel basis of each of the RLC layer and the PDCP layer. For example, in an embodiment of the present disclosure, in the RLC layer and the PDCP layer, in each of a plurality of logic channels, a task may be previously designed and defined, and thus in the embedded system, a task of each logic channel is generated in each of the RLC layer and the PDCP layer according to a design and a definition. For example, each of the RLC layer and the PDCP layer is formed with a first logic channel to a third logic channel, the system generates a first RLC layer task and a first PDCP layer task for the first logic channel, generates a second RLC layer task and a second PDCP layer task for a second logic channel, and generates a third RLC layer task and a third PDCP layer task for a third logic channel, thereby performing a processing of the RLC layer and the PDCP layer of a corresponding logic channel with each task.

In another embodiment of the present disclosure, based on a characteristic that should process data corresponding to a specific component carrier through each logic channel in the RLC layer and the PDCP layer, a task may be operated on a pair basis of a logic channel and a component carrier. For example, when the first logic channel should process data corresponding to a first component carrier and a second component carrier, the first logic channel may generate and operate a first RLC layer task and a first PDCP task of the first logic channel and the first component carrier and generate and operate a second RLC layer task and a second PDCP task of the first logic channel and a second component carrier.

In an LTE-A protocol layer structure, a task of each layer may be virtually and simultaneously performed. For example, for a downlink packet or data, a processing is performed in order of a PHY layer, a MAC layer, an RLC layer, and PDCP, and for a uplink packet or data, a processing is performed in reverse order and thus, it may be understood that a task of each layer may be sequentially performed. In an actual operation, a packet or data should arrive and be processed without disconnection every moment and thus, each layer should virtually and simultaneously be able to perform a corresponding work like a pipeline operation.

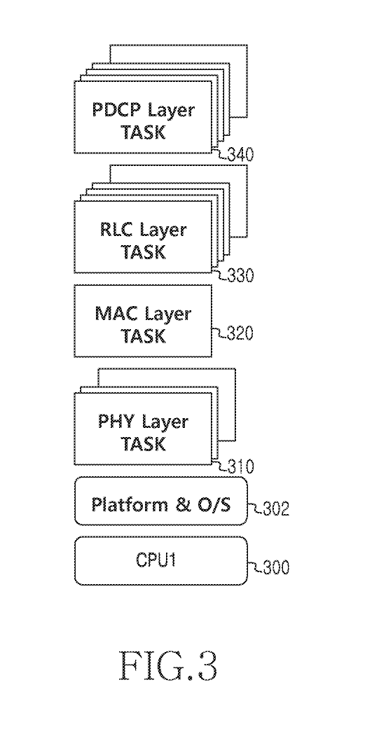

The foregoing method for operating a task is a method that does not consider a restriction of a hardware resource (e.g., a CPU) and may operate a task with a method shown in FIGS. 3, 4, and 5 based on a restriction of a hardware resource. The method for operating a task shown in FIGS. 3, 4, and 5 is some embodiment of various embodiments of the present disclosure and a range of the present disclosure is not limited thereto.

FIG. 3 illustrates a method for operating a task using one CPU core in an embedded system according to an embodiment of the present disclosure.

Referring to FIG. 3, if an entire data speed to process within a system is smaller than or equal to a threshold value, it is determined that entire data can be processed in one CPU, and a platform and operating system 302 may process tasks 310, 320, 330, and 340 of an entire layer through one CPU 300. Here, a threshold value may be set in a maximum velocity that can process in one CPU. For example, when it is estimated that a maximum velocity that can be processed by one CPU is 100 Mbps, a threshold value may be set to 100 Mbps.

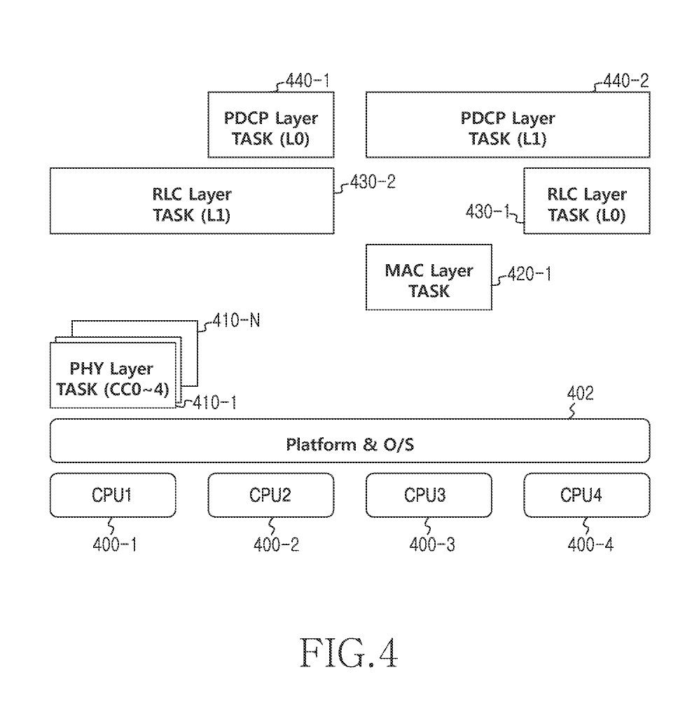

FIG. 4 illustrates a method for operating a task using a plurality of CPU cores in an embedded system according to an embodiment of the present disclosure.

Referring to FIG. 4, if an entire data speed to process within an embedded system is larger than a threshold value, it is determined that a processing of entire data is impossible in one CPU, and a platform and operating system 402 may process tasks of each layer through a plurality of CPUs 400-1 to 400-4. In this case, the number of used CPUs may be changed according to an amount of data and an entire data processing speed.

FIG. 4 illustrates a situation in which five component carriers CC0 to CC4 are activated and two logic channels L0 and L1 are operated in an embedded system having four CPUs (400-1 to 400-4). Further, in this case, it is assumed that the logic channel L0 processes traffic of several Mbps and that the logic channel L1 processes traffic of 1 Gbps. According to an embodiment of the present disclosure, the platform and operating system 402 may process tasks 410-1 to 410-N of each of five component carriers using a first CPU 400-1 and process a MAC layer task 420-1 using the third CPU 400-3. Further, the platform and operating system 402 may process an RLC layer task 430-1 of the logic channel L0 using the fourth CPU 400-4 and process a PDCP layer task 440-1 of the logic channel L0 using a second CPU 400-2. For example, even if tasks of the same logic channel exist, tasks corresponding to other layers may be processed through other CPUs according to an amount of data and data processing speed. Further, an RLC layer task 430-2 of the logic channel L1 may be processed using the first CPU 400-1 and the second CPU 400-2, and a PDCP layer task 440-2 of the logic channel L0 may be processed using the third CPU 400-3 and the fourth CPU 400-4. Here, a task of the logic channel L1 is processed using two CPUs because the logic channel L1 should generally process a workload more than a workload that can process in one CPU. However, because one task cannot be actually performed in two CPUs, the RLC layer task 430-2 and the PDCP layer task 440-2 of the logic layer L1 may be operated with a multi-thread method.

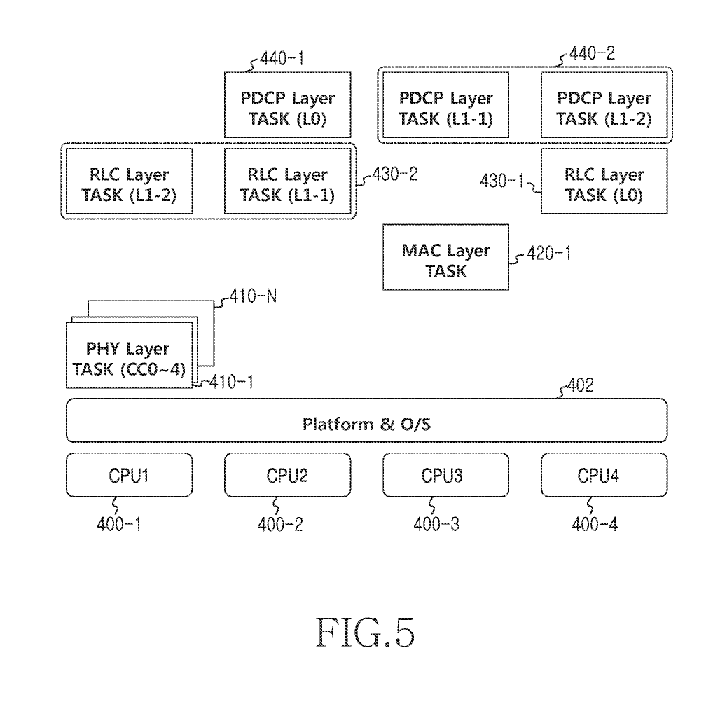

FIG. 5 illustrates a method for operating a task based on a plurality of threads using a plurality of CPU cores in an embedded system according to an embodiment of the present disclosure.

Referring to FIG. 5, each of the RLC layer task and the PDCP layer task 440-2 of the logic channel L1 is divided into two tasks and one task divided in one CPU may be processed.

In an embodiment of the present disclosure, as described above, a task may be operated based on a protocol layer structure and a workload. In addition, in an embedded system, a task may be generated, an executing task may be divided into at least two tasks, or the executing of the at least two tasks may be combined to one task according to a variable situation of a workload in which each task should process.

For example, in a situation in which an amount of data that should process in one logic channel is varied from 0 Mbps to 1 Gbps, an RLC layer task and a PDCP layer task of a corresponding logic channel should be able to process data from 0 Mbps to 1 Gbps according to a situation. In such a situation, a method for operating a task by generating, dividing, or combining the task may be, for example, as follows. Here, for convenience of description, a task of an RLC layer for a logic channel is described with, for example, task generation, division, and combination methods. However, the following description is not limited thereto and a task of a PDCP layer of a logic channel, a PHY layer task of a component carrier, a task of an RLC layer and a PDCP layer of a logic channel and component carrier pair, and a task of a MAC layer may be applied with the same method.

### Task Generation

In an embedded system, at least one RLC layer task corresponding to each logic channel may be generated according to a processing workload on a logic channel basis. For example, if an initial workload of a specific logic channel is smaller than 100 Mbps, the system may generate one RLC layer task of a specific logic channel and process a generated task in one CPU. In another example, if an initial workload of a specific logic channel is about 1 Gbps, the system may generate a plurality of RLC layer tasks for a specific logic channel and enable the generated plurality of RLC layer tasks to be processed through one CPU or a plurality of CPUs.

### Task Division

An embedded system may divide and operate one RLC layer task into two RLC layer tasks according to a varying workload of a specific logic channel. For example, if an initial workload of a specific logic channel is smaller than 100 Mbps, the system may process an RLC layer task of a specific logic channel through one CPU, and when a workload of a specific logic channel increases to 1 Gbps according to a temporal change, a workload of 1 Gbps cannot be processed with one CPU and thus, an RLC layer task of a specific logic channel may be divided into a plurality of tasks, and a CPU to process each of four divided RLC layer tasks may be determined based on a use rate or a state of a plurality of CPUs. In this case, the division number of tasks may be determined based on a workload to process and the number of CPUs that can use, and the number of CPUs that can use may be determined according to a present use rate, the remaining effective throughput, and a state (e.g., an idle state, an active state, and the like) of each CPU. Here, task division may be performed through a method for dividing a work content of the executing basic task into a plurality of work contents, resetting a portion of the divided work content to a work content of a basic task, and generating at least one task that performs the divided remaining works.

### Task Combination

In an embedded system, corresponding RLC layer tasks may be combined and operated to one task according to a varying workload of a specific logic channel. For example, when an initial workload of a specific logic channel is 1 Gbps, the system may process a plurality of RLC layer tasks of a specific logic channel through a plurality of CPUs, and when a workload of a specific logic channel is reduced to 100 Mbps or less according to a temporal change, a workload of 100 Mbps may be processed with one CPU and thus, corresponding plurality of RLC layer tasks are combined into one and the combined one RLC layer task may be processed through one CPU. In this case, task switching and message exchange between tasks may be decreased and thus, efficiency can be improved. Here, task combination may be performed through a method for removing the remaining task, except for one task of at least two tasks to combine and resetting a work content of one task that is not removed.

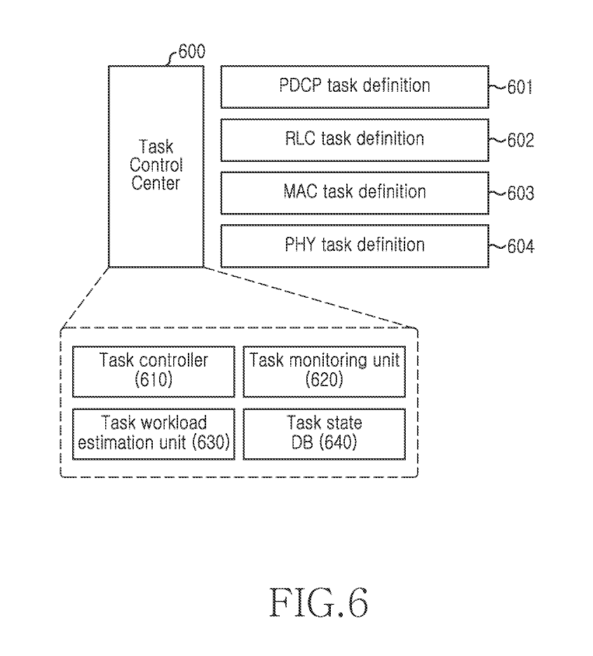

FIG. 6 is a block diagram illustrating a configuration for controlling a task in an embedded system according to an embodiment of the present disclosure.

Referring to FIG. 6, as described above, the embedded system may include a task control center 600 for a task generation, a division, or a combination. The task control center 600 may include at least one program including instructions that perform the foregoing embodiment of the present disclosure. More particularly, the task control center 600 may include task definitions 601, 602, 603, and 604, a task controller 610, a task monitoring unit 620, a task workload estimation unit 630, and a task state DB 640, of each layer.

The task control center 600 includes a task definition of each layer of a protocol. For example, the task control center 600 may include a PHY task definition 604 representing a method, a rule, or a condition of generating a task of a PHY layer, a method for generating a task of an RLC layer, the MAC task definition 603 representing a method, a rule, or a condition of generating a task of a MAC layer, the RLC task definition 602 representing a method, a rule, or a condition of generating a task of an RLC layer, and the PDCP task definition 601 representing a method, a rule, or a condition of generating a task of a PDCP layer. In this case, a task definition of each layer may have a correlation in a task definition of another layer. For example, the RLC task definition 602 and the PDCP task definition 601 may define a basic work task of both an RLC layer and a PDCP layer. Further, a task definition of each layer may define a basic work task in a range smaller than that of each layer.

The task control center 600 performs the control for generating, dividing, or combining a task according to a varying workload based on a task definition of each layer using the task controller 610, the task monitoring unit 620, the task workload estimation unit 630, and the task state DB 640.

More specifically, the task controller 610 performs a control function for generating, dividing, or combining a task of each layer based on a monitor result of the task monitoring unit 620 and an estimation result of the task workload estimation unit 630. The task controller 610 may generate and control a task with a method for generating an operation memory of each task based on a task definition, i.e., a task frame and forming a data area corresponding to a needed work.

The task monitoring unit 620 monitors an operation situation of a task and a CPU operation situation in real time or periodically and provides a monitor result to the task controller 610. For example, the task monitoring unit 620 may distinguish a task executing in each layer and distinguish a task processed in each CPU.

The task workload estimation unit 630 estimates a change of a workload of each of presently executing tasks based on a monitor result of the task monitoring unit 620 and estimates a workload change of each CPU by a task processed in each CPU. Here, the task workload estimation unit 630 may estimate a workload change with a cooperation with a task related to modem hardware and protocol operation.

The task state DB 640 stores and manages state information of each task. For example, the task state DB 640 may store an estimation workload, a work content, a processing CPU, task identification information, corresponding logic channel identification information, or corresponding component carrier identification information of each task.

As described above, the task control center 600 may exist as a separate task for task generation, division, and combination and be included in a definition of a basic work task. For example, a function of a task control center may be included as a function of a root task to become the base, and the root task may generate a new task or divide or combine an executing task based on a workload and a CPU to process.

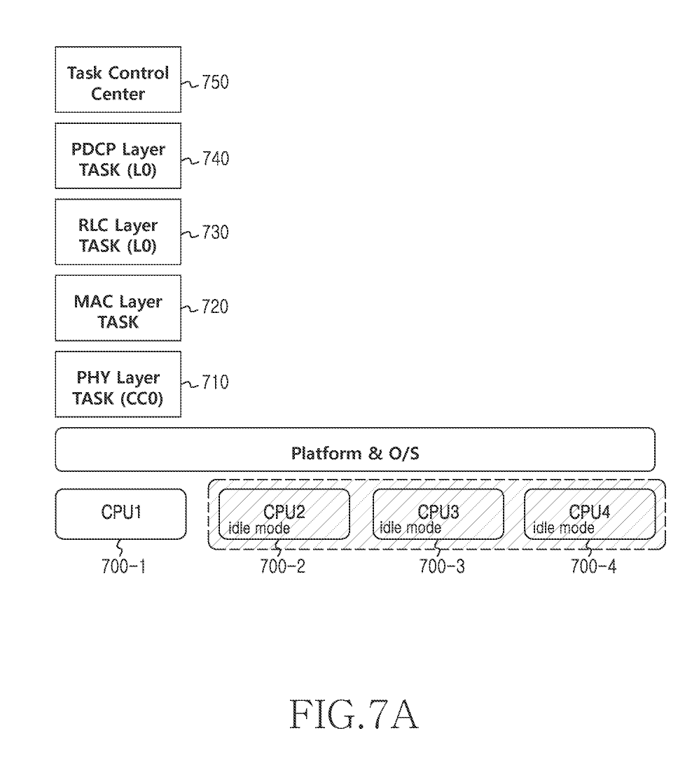

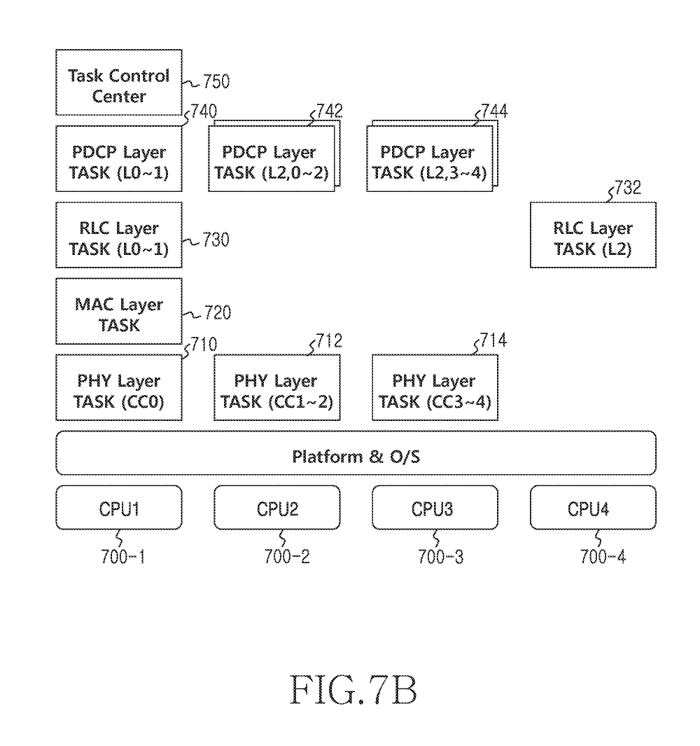

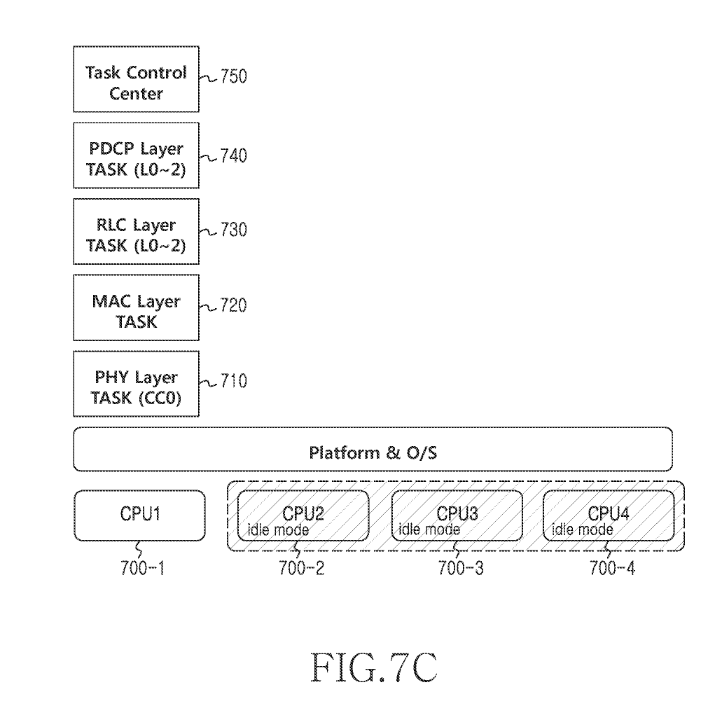

FIGS. 7A, 7B, and 7C illustrate a task a generation, a division, and a combination according to a varying workload in an embedded system according to an embodiment of the present disclosure. Here, an embedded system having four CPUs is exemplified.

First, at least one application operates in the electronic device and thus, in a task control center, one logic channel L0 for data communication exists, and in the logic channel L0, and data traffic of several Mbps (e.g., 1 Mbps) is requested. In this case, it is assumed that one component carrier CC0 is needed.

Referring to FIGS. 7A, 7B, and 7C, a task control center 750 determines whether a workload can be processed in one CPU, and as shown in FIG. 7A, the task control center 750 generates one task 710, 720, 730, and 740 for respectively layers and allocates tasks 710, 720, 730, and 740 of generated respectively layers to a first CPU 700-1 in an idle state. In this case, the task control center 750 may allocate generated tasks 710, 720, 730, and 740 to a plurality of CPUs 700-1 to 700-4, respectively, based on a state, a present use rate, and the remaining effective throughput of a plurality of CPUs 700-1 to 700-4. For example, in FIG. 7A, tasks 710, 720, 730, and 740 of an entire layer are allocated to the first CPU 700-1, but tasks 710, 720, 730, and 740 of a layer may be allocated to other CPUs.

Hereinafter, while operating a task, as shown in FIG. 7A, a situation in which division of a task, i.e., resetting and new generation of a task is needed due to operation of an application is exemplified. In an electronic device, a task control center detects that a plurality of component carriers operate and in RLC and PDCP layers, it is assumed that a present situation is a situation in which a plurality of execution entities that should process data of a high speed exist due to operation of an application. For example, in the task control center 750, a logic channel increases to three of L0, L1, and L2, L0 and L1 needs a traffic processing of 1 Mbps, and L2 temporarily needs traffic processing of 1 Gbps, and thus, it is assumed that the task control center 750 detects a situation in which 5 component carriers are needed. In this case, in order to allocate a task on an execution entity basis of each layer, the task control center 750 may divide a task. Here, task division is to reset an executing task and to generate a new task in relation thereto.

The task control center 750 may reset an RLC layer task 730 of a logic channel L0 generated in FIG. 7A, enable the corresponding task 730 to perform a processing of both logic channels L0 and L1, as shown in FIG. 7B, and additionally generate a new task 732 that performs a processing of L2. Further, the task control center 750 may reset a PDCP layer task 740 of a logic channel L0 generated in FIG. 7A, enable the corresponding task 740 to perform a processing of both logic channels L0 and L1, as shown in FIG. 7B, and additionally generate new tasks 742 and 744 that performs a processing of L2. Further, the task control center 750 may maintain a PHY layer task 710 of a generated component carrier CC0 shown in FIG. 7A and may generate a new task 712 that performs a processing of CC1 to CC2 and a new task 714 that performs a processing of CC3 to CC4, as shown in FIG. 7B. Here, as L2 temporarily requests a traffic processing of 1 Gbps, 5 component carriers are requested, and the task control center 750 may determine that a processing of an entire layer of L2 cannot be performed with one CPU and generate two tasks operating in two different CPUs of at least one layer. For example, a task of a PDCP layer that performs a processing of L2 may be formed with one task that processes data corresponding to component carriers 0 and 1 and three tasks that process data corresponding to each of component carriers 2, 3, and 4 among 5 component carriers in which L2 uses. Here, the task control center 750 may perform task division, i.e., task resetting and new task generation of each layer and allocate the reset or new generated task to each CPU based on a workload and the number of CPUs, a state of a CPU, a use rate of a CPU, and the remaining effective throughput of a CPU.

Further, the task control center 750 may allocate an RLC layer task 732 and PDCP layer tasks 742 and 744 of L2 to other CPUs 700-2 to 700-4 in an idle state in consideration that a task of L2 needs a traffic processing of 1 Gbps. As a CPU4 700-4 should perform other work, when the CPU4 700-4 cannot perform a traffic processing of 1 Gbps in which L2 needs, the task control center 750 may divide the RLC layer task 732 of L2 allocated to the CPU4 700-4 into a plurality of tasks and allocate divided partial tasks to other CPUs.

In such a situation, the task control center 750 continues to monitor a use rate of a CPU1 700-1, and when a use rate of the CPU1 700-1 maintains a state enough for processing tasks 730 and 740 of RLC and PDCP layers of L0 and L1, the task control center 750 may maintain an operation state of tasks 730 and 740 of RLC and PDCP layers of L0 and L1. In contrast, the task control center 750 continues to monitor a use rate of the CPU1 700-1, and when a use rate of the CPU1 700-1 exceeds 80% and is changed to a state that is not enough to process the tasks 730 and 740 of RLC and PDCP layers of L0 and L1, the task control center 750 may divide again the tasks 730 and 740 of the RLC and PDCP layers of L0 and L1.

Hereinafter, as shown in FIG. 7B, while operating a task, due to operation of an application, a situation in which a combination of a task, i.e., removal and resetting of a task, is needed is exemplified. For example, as shown in FIG. 7B, while operating a task, when a situation is changed to a situation in which L2 needs a processing of 1 Mbps instead of processing traffic of 1 Gbps, the task control center 750 may determine that a processing in which L0 to L2 need in one CPU is available, combine an executing plurality of tasks to one task on an each layer basis and allocate the one task to the CPU1 700-1, as shown in FIG. 7B. In this case, as shown in FIG. 7B, the task control center 750 may reset tasks of L0 and L1 among five tasks operating in a PDCP layer to a task of L0 to L2 and remove (or delete) the remaining tasks and thus, combine and operate tasks of five PDCP layers to one PDCP layer task 740, as shown in FIG. 7C. Further, as shown in FIG. 7B, the task control center 750 may reset tasks of L0 and L1 of two tasks operating in an RLC layer to tasks of L0 to L2 and remove (or delete) the remaining task and thus, combines and operate tasks of two RLC layers to one RLC layer task 730, as shown in FIG. 7C. Further, as shown in FIG. 7B, the task control center 750 may remove (or delete) the remaining tasks, except for a task of CC0 among 3 tasks operating in a PHY layer and combine and operate tasks of three PHY layers to one PHY layer task 710, as shown in FIG. 7C. Here, the number of component carriers requested due to decrease of requested data traffic may be reduced and thus, the task number of the PHY layers may be reduced.

In the foregoing embodiment of the present disclosure, a case in which a separate task is defined on PDCP, RLC, MAC, and PHY layers basis has been described. However, when a task that integrates and processes all of PDCP, RLC, MAC, and PHY layers is defined according to another embodiment of the present disclosure, inefficiency may be removed by task switching and message exchange between tasks. For example, as a user terminates a direct work, in a situation in which a background work, such as e-mail synchronization remains, by performing an entire work with one task instead of maintaining a task on a layer basis, task switching or message exchange between tasks is not performed and thus, efficiency of a system may be improved.

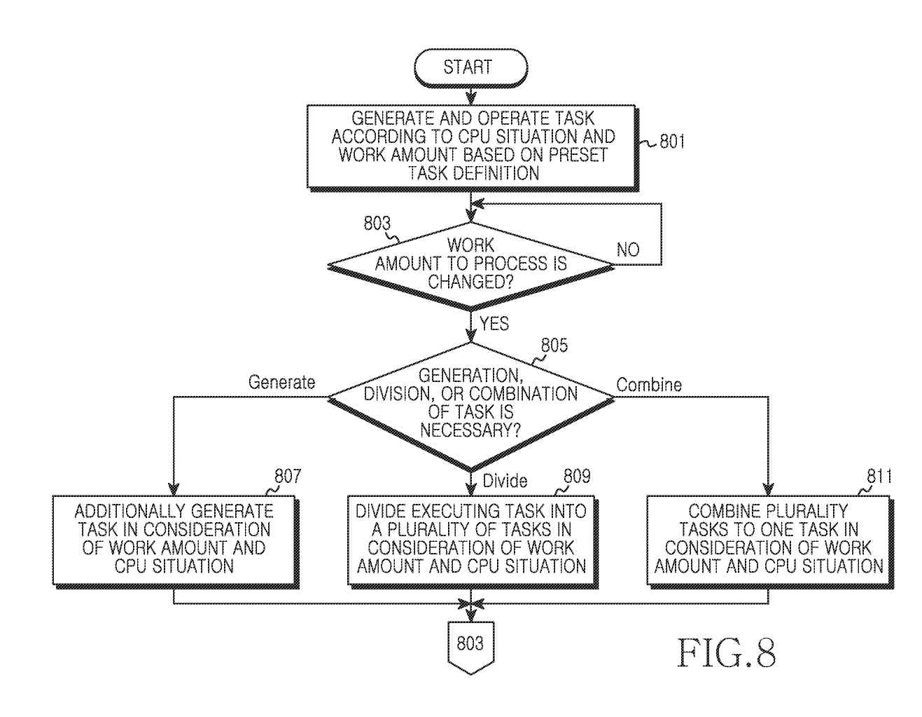

FIG. 8 is a flowchart illustrating a task operation procedure in an embedded system according to an embodiment of the present disclosure.

Referring to FIG. 8, the system generates and operates a task according to a CPU situation and a workload to process in the system based on a preset task definition in operation 801. Here, a workload may include at least one of an amount of data to process and a requested data traffic speed. Further, the CPU situation may include at least one of the number of CPUs, a CPU state, a present CPU use rate, and the remaining effective throughput of a CPU. In this case, the system may generate at least one task on an each layer basis based on a protocol structure on a layer basis. In this case, tasks of each layer may be allocated to one CPU based on a workload and a CPU situation and may be allocated to other CPUs. Further, when a plurality of tasks are generated within one layer, a plurality of tasks may be allocated to one CPU based on a workload and a CPU situation and may be allocated to other CPUs. Further, one task for a specific layer may be allocated to a plurality of CPUs through a multi-thread method.

The system determines whether a workload to process is changed in operation 803. For example, in operation 801, traffic of 1 Mbps was requested within the system, but it is determined whether traffic of 1 Gbps is requested within the system through a determination of operation 803.

If it is determined in operation 803 that a workload to process is changed, the system determines whether generation, division, or a combination of a task is needed in operation 805. For example, the system determines whether a workload and a CPU situation are changed or a new work occurs and determines whether generation, division, or a combination of a task is needed.

When a new work occurs within a system and thus, when the number of logic channels increases, the system may determine task generation. In another example, when traffic requested in a specific logic channel within the system is changed to a threshold value or more, the system may determine task division. In another example, when traffic requested in a specific logic channel within the system is changed to a threshold value or less, the system may determine task combination.

If it is determined in operation 805 that task generation is needed, the system may additionally generate a task based on a workload and a CPU situation in operation 807. In this case, the task may be additionally generated on each layer basis and may be additionally generated for a specific layer.

If it is determined in operation 805 that task division is needed, the system may divide a presently executing task into a plurality of tasks based on a workload and a CPU situation in operation 809. In this case, task division may be performed through a method for dividing a workload to process into a plurality of workloads, resetting a workload of a presently executing task to divided partial workloads, and generating at least one task that performs the remaining workloads of the divided workload.

If it is determined in operation 805 that task combination is needed, the system may combine an executing plurality tasks to one task based on a workload and a CPU situation in operation 811. In this case, task combination may be performed through a method for resetting corresponding one task so that one task of a presently executing plurality of tasks performs an entire workload and removing other tasks that is not reset.

According to an embodiment of the present disclosure, in an embedded system of an electronic device, by generating, dividing, or combining and operating a task based on a varying workload and power efficiency, a processing performance and power efficiency of the electronic device can be improved.

Certain aspects of the present disclosure can also be embodied as computer readable code on a non-transitory computer readable recording medium. A non-transitory computer readable recording medium is any data storage device that can store data which can be thereafter read by a computer system. Examples of the non-transitory computer readable recording medium include a Read Only Memory (ROM), a Random Access Memory (RAM), Compact Disc (CD)-ROMs, magnetic tapes, floppy disks, and optical data storage devices. The non-transitory computer readable recording medium can also be distributed over network coupled computer systems so that the computer readable code is stored and executed in a distributed fashion. In addition, functional programs, code, and code segments for accomplishing the present disclosure can be easily construed by programmers skilled in the art to which the present disclosure pertains.

At this point it should be noted that the various embodiments of the present disclosure as described above typically involve the processing of input data and the generation of output data to some extent. This input data processing and output data generation may be implemented in hardware or software in combination with hardware. For example, specific electronic components may be employed in a mobile device or similar or related circuitry for implementing the functions associated with the various embodiments of the present disclosure as described above. Alternatively, one or more processors operating in accordance with stored instructions may implement the functions associated with the various embodiments of the present disclosure as described above. If such is the case, it is within the scope of the present disclosure that such instructions may be stored on one or more non-transitory processor readable mediums. Examples of the processor readable mediums include a ROM, a RAM, CD-ROMs, magnetic tapes, floppy disks, and optical data storage devices. The processor readable mediums can also be distributed over network coupled computer systems so that the instructions are stored and executed in a distributed fashion. In addition, functional computer programs, instructions, and instruction segments for accomplishing the present disclosure can be easily construed by programmers skilled in the art to which the present disclosure pertains.

While the present disclosure has been shown and described with reference to various embodiments thereof, it will be understood by those skilled in the art that various changes in form and details may be made therein without departing from the spirit and scope of the present disclosure as defined by the appended claims and their equivalents.

What is claimed is:

1. A method for operating a task in an electronic device, the method comprising:
generating at least one task on a protocol layer basis based on a work to process;
executing at least one task generated on a layer basis through at least one Central Processing Unit (CPU);
determining whether a workload to process is changed; and
changing, if the workload to process is changed, a workload of the executing of the at least one task.

2. The method of claim 1, wherein the generating of at least one task comprises generating a separate task on an execution entity basis constituting the each layer for each layer of the protocol.

3. The method of claim 1, wherein the executing of the at least one task comprises determining a CPU to process each of at least one task generated on the layer basis based on a situation of the at least one CPU, and
wherein the situation of the at least one CPU comprises at least one of a number of CPUs, a CPU state, a present processing ratio of a CPU, and a remaining effective throughput of the at least one CPU.

4. The method of claim 3, wherein the at least one task is processed using multi-thread, when two CPUs to process the at least one task are determined as a CPU to process each of the at least one task.

5. The method of claim 1, wherein the changing of the workload of the executing of the at least one task comprises dividing the executing of the at least one task into a plurality of tasks, and
wherein the divided plurality of tasks are allocated to one CPU or a plurality of CPUs.

6. The method of claim 5, wherein the dividing of the executing of the at least one task comprises:
dividing a workload of the executing of the at least one task into a plurality of workloads;
resetting a workload of the executing of the at least one task using at least one workload of the divided plurality of workloads; and
generating at least one task that processes the remaining workload of the divided plurality of workloads.

7. The method of claim 1, wherein the changing of the workload comprises combining the executing of at least two tasks into one task, and
the combined one task is allocated to one CPU.

8. The method of claim 7, wherein the combining of the executing of the at least two tasks comprises:
resetting a workload of one task of the executing of the at least two tasks using a workload of the executing of the at least two tasks; and
removing the remaining task of the executing of the at least two tasks.

9. An electronic device for operating a task in an electronic device, the device comprising:
an embedded system configured to generate at least one task on a protocol layer basis based on a work to process, to execute at least one task generated on the layer basis through at least one Central Processing Unit (CPU), to determine whether a workload to process is changed, and to change a workload of the executing of the at least one task, if a workload to process is changed.

10. The device of claim 9, wherein the embedded system is further configured to generate a separate task on an execution entity basis constituting each layer of the protocol.

11. The device of claim 9, wherein the embedded system is further configured to determine a CPU to process each of at least one task generated on the layer basis based on a situation of the at least one CPU, and
wherein the situation of the at least one CPU comprises at least one of a number of CPUs, a CPU state, a present processing ratio of a CPU, and a remaining effective throughput of the at least one CPU.

12. The device of claim 11, wherein the embedded system is further configured to process the at least one task using multi-thread, when two CPUs to process the at least one task are determined as a CPU to process each of at least one task.

13. The device of claim 9, wherein the embedded system is further configured to divide the executing of the at least one task into a plurality of tasks and to allocate the divided plurality of tasks to one CPU or a plurality of CPUs.

14. The device of claim 13, wherein the embedded system is further configured to divide a workload of the executing of the at least one task into a plurality of workloads, to reset a workload of the executing of the at least one task using at least one workload of the divided plurality of workloads, and to process the remaining workloads of the divided plurality of workload.

15. The device of claim 9, wherein the embedded system is further configured to combine the executing of at least two tasks into one task and to allocate the combined one task to one CPU.

16. The device of claim 15, wherein the embedded system is further configured to reset a workload of one task of the executing of the at least two tasks using a workload of the executing of the at least two tasks and to remove the remaining task of the executing of the at least two tasks.

17. A non-transitory computer readable medium for storing a computer program of instructions configured to be readable by at least one processor for instructing the at least one processor to execute a computer process for performing the method of claim 1.
